(19) United States
(12) Patent Application Publication
(10) Pub. No.: US 2010/0056263 A1
(43) Pub. Date: Mar. 4, 2010

(54) GAMING SYSTEM AND A METHOD OF GAMING

(75) Inventor: Michael Thomas McNee, Cammeray (AU)

Correspondence Address: HANLEY, FLIGHT & ZIMMERMAN, LLC, 150 S. WACKER DRIVE, SUITE 2100, CHICAGO, IL, 60606, US

(73) Assignee: ARISTOCRAT TECHNOLOGIES AUSTRALIA PTY LIMITED, North Ryde (AU)

(21) Appl. No.: 12/551,998

(22) Filed: Sep. 1, 2009

(30) Foreign Application Priority Data
Sep. 2, 2008 (AU) 2008904557

(51) Int. Cl. A63F 9/24; A63F 13/00

(52) U.S. Cl. 463/25; 463/30; 463/36

(57) ABSTRACT

A method of gaming is provided where a game can be played with an outcome. An area is provided to permit a player to interact with game play. If there is a detection of player interaction, a randomly applied bonus is applied for a game outcome.

### CROSS-REFERENCE TO RELATED APPLICATIONS

The present application claims the benefit of priority to Australian Provisional Patent Application No. 2008904557, filed on Sep. 2, 2008, entitled “A GAMING SYSTEM AND A METHOD OF GAMING”, which is herein incorporated by reference in its entirety.

### FIELD

The present disclosure relates to a gaming system, a method of gaming, a game controller and computer program code.

### BACKGROUND

It is known to provide a gaming system which includes a game controller arranged to randomly display several symbols from a predetermined set of symbols and to determine a game outcome such as a game win based on the displayed symbols. Such gaming systems may commonly be implemented as a stepper machine provided with reels with each reel carrying several symbols of the set, or a video machine wherein selected symbols are displayed on virtual reels on a video display.

While such gaming systems provide users with enjoyment, a need exists for alternative gaming systems in order to maintain or increase player enjoyment.

### SUMMARY OF THE INVENTION

In a first aspect, the invention provides a method of gaming including:

providing provision for game play with an outcome,

prior to generation of a game outcome, providing an area with which a player can interact,

detecting a player's interaction with the area and as a consequence randomly applying a bonus for a game outcome.

In an embodiment gaming is undertaken on a video gaming machine and displaying said area on a display screen thereof.

In an embodiment said area is represented by a mascot which is displayed on said display screen.

In a second aspect, the invention provides a game controller for a gaming machine, the game controller arranged to:

generate a game outcome on said gaming machine, and to provide an area with which a player will interact,

said game controller being able to receive an input indicating player interaction with said area and to randomly apply a bonus for a game.

In an embodiment the game controller is a video game machine, and said game controller provides said area on a display screen thereof.

In an embodiment said game controller represents said area in the form of a mascot.

In a third aspect, the invention provides a gaming system including:

a display to enable a player to view game play and to provide an area for player interaction, and a game controller as set out above.

In a fourth aspect, the invention provides a computer program code which when executed by a processor in a computer implements the above method of gaming.

In a fifth aspect the invention provides a computer readable medium including the program code as set out above.

### BRIEF DESCRIPTION OF THE DRAWINGS

Certain embodiments of the invention will now be described in relation to the following drawings in which:

FIG. 1 is a block diagram of the core components of a gaming system;

FIG. 2 is a perspective view of a gaming machine;

FIG. 3 is a block diagram of the functional components of a gaming machine;

FIG. 4 is a block diagram representing the structure of a memory;

FIG. 5 is a diagram schematic of a networked gaming system;

FIG. 6 is a further block diagram of the gaming system; and

FIG. 7 is a flowchart of an embodiment.

Features, further aspects, and advantages of the present invention will become apparent from the following description of embodiments thereof, by way of example only, with reference to the accompanying drawings. Also, various embodiments of the aspects described in the preceding paragraphs will be apparent from the appended claims, the following description and/or the accompanying drawings. It should be understood, however, that the present invention is not limited to the arrangements and instrumentality shown in the attached drawings.

### DETAILED DESCRIPTION OF CERTAIN EMBODIMENTS

Although the following discloses example methods, systems, articles of manufacture, and apparatus including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods, systems, articles of manufacture, and apparatus, the examples provided are not the only way to implement such methods, systems, articles of manufacture, and apparatus.

When any of the appended claims are read to cover a purely software and/or firmware implementation, in at least one embodiment, at least one of the elements is hereby expressly defined to include a tangible medium such as a memory, DVD, CD, etc. storing the software and/or firmware.

An embodiment provides a gaming system where a player plays at least one game, and preferably a sequence of games. Here the game has a plurality of symbols for use during game play and from which game win outcomes can be determined. An area is provided which is able to be interactive with the player. If the player interacts with the area a randomly applied bonus can be applied to that particular game.

The gaming system may be provided in a number of different forms.

In a first form, a stand alone gaming machine is provided wherein all or most components to implement the game are present in a player operable gaming machine.

In a second form, a distributed architecture is provided wherein some of the components to implement the game are present in a player operable gaming machine and some of the components to implement the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

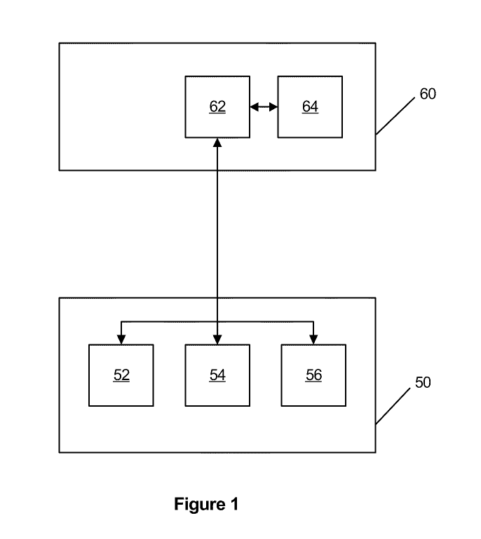

Irrespective of the form, the gaming system includes several core components. At the broadest level, the core components are a player interface 50 and a game controller 60 as illustrated in FIG. 1. The player interface is arranged to enable manual interaction between a player and the gaming system and for this purpose includes the input/output components for the player to enter instructions and play the game.

Components of the player interface may vary from embodiment to embodiment but will typically include a credit mechanism 52 to enable a player to input credits and receive payouts, one or more displays 54 and a game play mechanism 56 that enables a player to input game play instructions and a sound reproducing device (not specially shown).

The game controller 60 is in data communication with the player interface and typically includes a processor 62 that processes the game play instructions in accordance with game play rules and outputs game play outcomes to the display. Typically, the game play instructions are stored as program code in a memory 64 but can also be hardwired. Herein the term “processor” is used to refer generically to any device that can process game play instructions in accordance with game play rules and may include: a microprocessor, microcontroller, programmable logic device or other computational device, a general purpose computer (e.g. a PC) or a server.

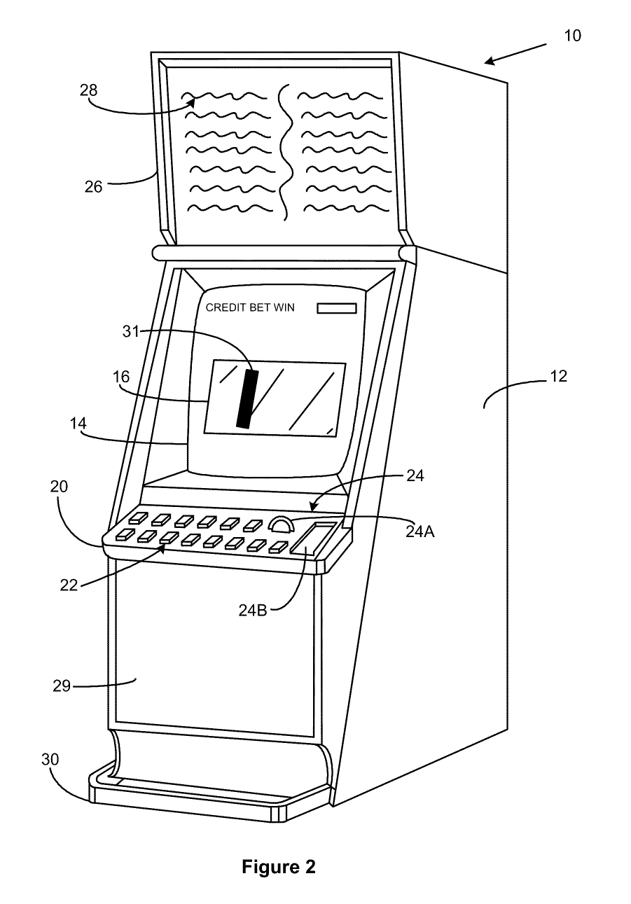

A gaming system in the form of a stand alone gaming machine 10 is illustrated in FIG. 2. The gaming machine 10 includes a console 12 having a display 14 on which is displayed representations of a game 16 that can be played by a player. A mid-trim 20 of the gaming machine 10 houses a bank of buttons 22 for enabling a player to interact with the gaming machine, in particular during game play. The mid-trim 20 also houses a credit input mechanism 24 which in this example includes a coin input chute 24A and a bill collector 24B. Other credit input mechanisms may also be employed, for example, a card reader for reading a smart card, debit card or credit card. A player marketing module has a reading device may also be provided for the purpose of reading a player tracking device, for example as part of a loyalty program. The player tracking device may be in the form of a card, flash drive or any other portable storage medium capable of being read by the reading device.

A top box 26 may carry artwork 28, including for example pay tables and details of bonus awards and other information or images relating to the game. Further artwork and/or information may be provided on a front panel 29 of the console 12. A coin tray 30 is mounted beneath the front panel 29 for dispensing cash payouts from the gaming machine 10.

The display 14 shown in FIG. 2 is in the form of a video display unit, particularly a cathode ray tube screen device. Alternatively, the display 14 may be a liquid crystal display, plasma screen, any other suitable video display unit, or the visible portion of an electromechanical device. The top box 26 may also include a display, for example a video display unit, which may be of the same type as the display 14, or of a different type.

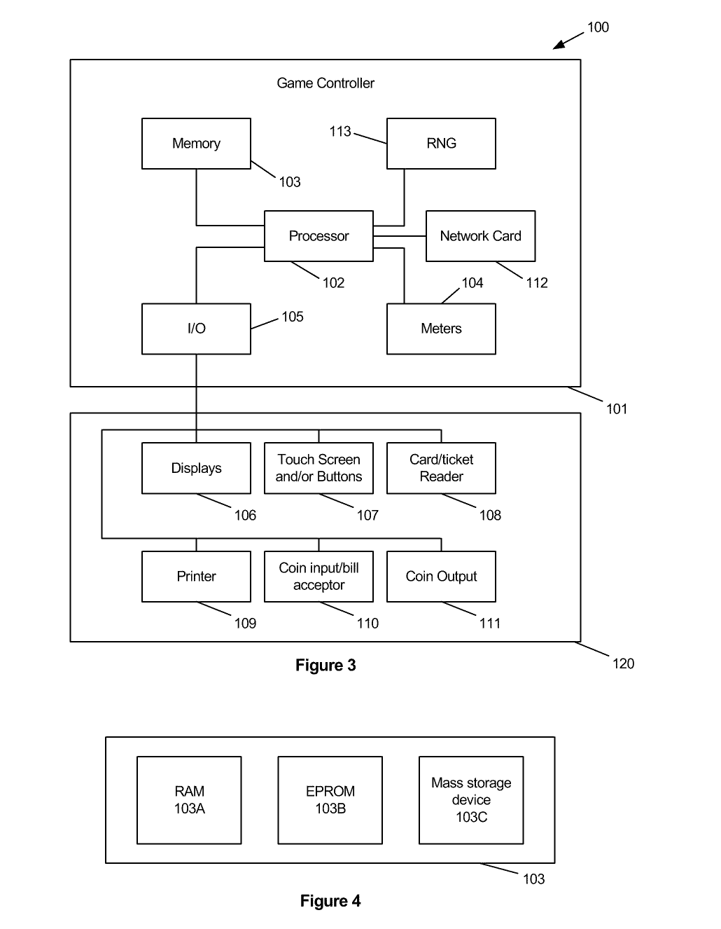

FIG. 3 shows a block diagram of operative components of a typical gaming machine which may be the same as or different to the gaming machine of FIG. 2.

The gaming machine 100 includes a game controller 101 having a processor 102. Instructions and data to control operation of the processor 102 are stored in a memory 103, which is in data communication with the processor 102. Typically, the gaming machine 100 will include both volatile and non-volatile memory and more than one of each type of memory, with such memories being collectively represented by the memory 103.

The gaming machine has hardware meters 104 for purposes including ensuring regulatory compliance and monitoring player credit, an input/output (I/O) interface 105 for communicating with peripheral devices of the gaming machine 100. The input/output interface 105 and/or the peripheral devices may be intelligent devices with their own memory for storing associated instructions and data for use with the input/output interface or the peripheral devices. A random number generator module 113 generates random numbers for use by the processor 102. Persons skilled in the art will appreciate that the reference to random numbers includes pseudo-random numbers.

In the example shown in FIG. 3, a player interface 120 includes peripheral devices that communicate with the game controller 101 include one or more displays 106, a touch screen 107 (or buttons for user interface), a card and/or ticket reader 108, a printer 109, a bill acceptor and/or coin input mechanism 110 and a coin output mechanism 111. Additional hardware may be included as part of the gaming machine 100, or hardware may be omitted based on the specific implementation.

In addition, the gaming machine 100 may include a communications interface, for example a network card 112. The network card may, for example, send status information, accounting information or other information to a central controller, server or database and receive data or commands from the central controller, server or database.

FIG. 4 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere.

It is also possible for the operative components of the gaming machine 100 to be distributed, for example input/output devices 106,107,108,109,110,111 to be provided remotely from the game controller 101.

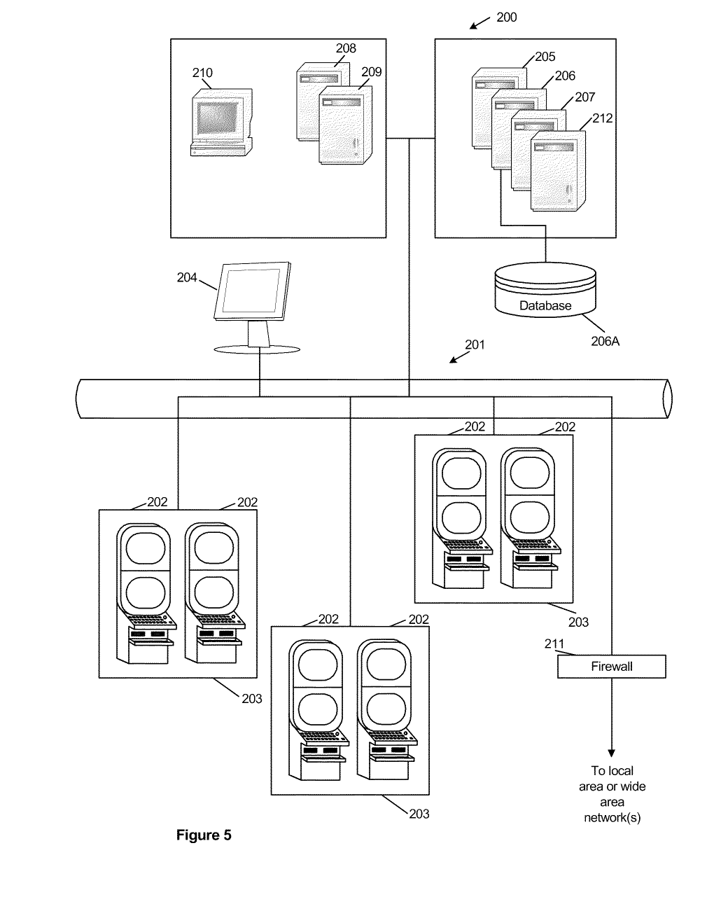

FIG. 5 shows a gaming system 200 in accordance with an alternative embodiment. The gaming system 200 includes a network 201, which for example may be an Ethernet network. Gaming machines 202, shown arranged in three banks 203 of two gaming machines 202 in FIG. 5, are connected to the network 201. The gaming machines 202 provide a player operable interface and may be the same as the gaming machines 10,100 shown in FIGS. 2 and 3, or may have simplified functionality depending on the rules, guidelines, preferences, and/or requirements for implementing game play. While banks 203 of two gaming machines are illustrated in FIG. 5, banks of one, three or more gaming machines are also envisaged.

One or more displays 204 may also be connected to the network 201. The displays 204 may, for example, be associated with one or more banks 203 of gaming machines. The displays 204 may be used to display representations associated with game play on the gaming machines 202, and/or used to display other representations, for example promotional or informational material.

In a thick client embodiment, game server 205 implements part of the game played by a player using a gaming machine 202 and the gaming machine 202 implements part of the game. With this embodiment, as both the game server and the gaming device implement part of the game, they collectively provide a game controller. A database management server 206 may manage storage of game programs and associated data for downloading or access by the gaming devices 202 in a database 206A. Typically, if the gaming system enables players to participate in a Jackpot game, a Jackpot server 207 will be provided to carry out the accounting in respect of the Jackpot game. A loyalty program server 212 may also be provided.

In a thin client embodiment, game server 205 implements most or all of the game played by a player using a gaming machine 202 and the gaming machine 202 essentially provides only the player interface. With this embodiment, the game server 205 provides the game controller. The gaming machine will receive player instructions, pass these to the game server which will process them and return game play outcomes to the gaming machine for display. In a thin client embodiment, the gaming machines could be computer terminals, e.g. PCs running software that provides a player interface operable using standard computer input and output components.

Servers are also typically provided to assist in the administration of the gaming network 200, including for example a gaming floor management server 208, and a licensing server 209 to monitor the use of licenses relating to particular games. An administrator terminal 210 is provided to allow an administrator to run the network 201 and the devices connected to the network.

The gaming network 200 may communicate with other gaming systems, other local networks, for example a corporate network, and/or a wide area network such as the Internet, for example through a firewall 211.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random generator engine. Alternatively, a separate random number generator server could be provided. Further, persons skilled in the art will appreciate that a plurality of games servers could be provided to run different games or a single game server may run a plurality of different games based on the terminals.

The embodiment may be implemented in relation to a spinning reel type game. Gaming systems for implementing games that involve a display of spinning reels as part of the display of the outcome of a game have either a video display or a mechanical display, these later machines most usually being “stepper” machines which have a separate motor for each reel. However, persons skilled in the art will appreciate that the invention can be implemented in respect if other forms of games, including; card games; ball draw games (e.g. bingo or keno); dice games; and pin and ball games, and that spinning reels can be replaced with columns with changing symbols.

In some implementations the game controllers of such gaming machines select symbols by employing a stop determining function that randomly determines the stop position for each reel. For example, if there are five reels, each having twenty symbols, the stop determining function might determine that the stop positions are positions: 3, 13, 7, 9 and 17. The spinning of the reels is then controlled so that each symbol comes to a stop in the same row, typically a predetermined row in a “window” visible to the player on the display that corresponds to a player playing a single win line. When a reel stops, the symbols will be in one of a plurality of possible symbol positions for that reel relative to the stop position.

Spinning reel type games typically allow a player to select how many win lines or a plurality of win lines they will play in each game—i.e. a minimum of one win line up to the maximum number of win lines allowed by the game. Persons, skilled in the art, will appreciate that in other embodiments, the player may select a number of reels to play. Each win line is formed by a set of symbol positions consisting of one symbol position from each reel. That is, a predetermined symbol position of each reel is assigned to a win line. The symbol positions that constitute each of the win lines are usually advertised to the player by markings on the display or diagrams showing the symbol positions that correspond to each win line. Some of the win lines will be horizontal or diagonal lines. A game outcome is determined based on the symbols on the win lines and a prize table that specifies awards.

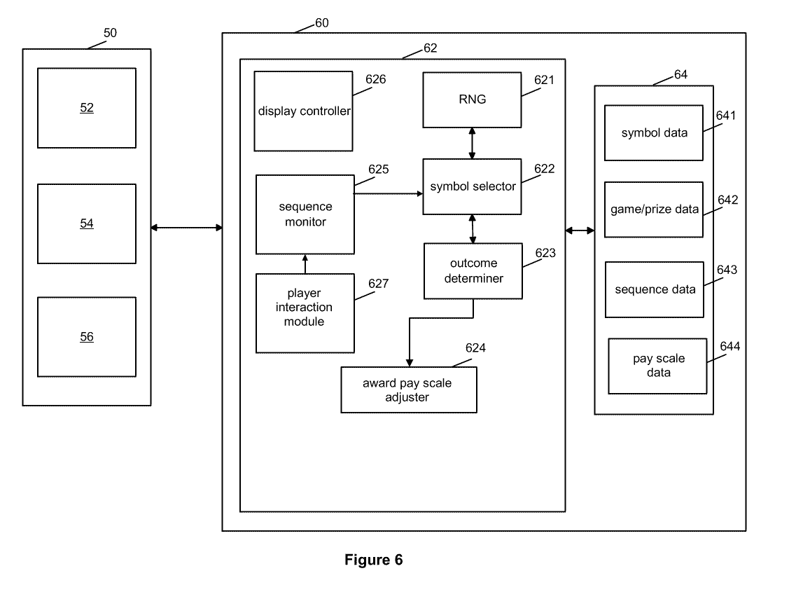

The game controller 60 of the embodiment is shown in more detail in FIG. 6. It will apparent that the processor 62 implements a number of modules, namely random number generator module 621, symbol selector module 622, outcome determiner module 623, award determiner module 624, sequence monitoring module 625, player interaction module 627 and display controller module 626 based on data stored in memory 64. Persons skilled in the art will appreciate that not all modules need be implemented by processor 62. For example, the random number generator module 621 could be implemented by a separate circuit or by a random number generator server.

In the embodiment, the player interaction module 627 determines if there has been player interaction with area 31 (see FIG. 1).

The player interaction module 627 instructs the sequence monitor 625 to initiate a random bonus a next game based on sequence data 643. This occurs when player interaction with area 31 prior to game play. This bonus may be applied for next game or some future game. In one variation the bonus may be applied for a current game.

During each game the symbol selector 622 selects the symbols to appear based on symbol data 641 which specifies the available symbols. The symbols are selected by the symbol selector using a random number obtained from the random number generator 621. The outcome determiner module 623 determines the game outcomes. The pay scale adjuster 624 then adjusts an amount for outcomes using pay scale data at 644. The adjustment is based on the number of win lines the player is playing and the symbol combinations. Persons skilled in the art will also appreciate that the game outcomes and their associated prizes are displayed on the display 54 under control of the display controller 626.

In an embodiment of the invention the area 31 is provided on the display 14 which is rendered player interactive by the game controller 60. The area 31 may be permanently displayed on the display 14 or it may be provided non visible to the player. Typically the area 31 corresponds to a visual component of game play such as the position of a symbol, or the position of a reel (in the case of a spinning reel type game). The area 31 may be made interactive by the display 14 being a touch screen and wherein the player interaction module 627 operatively selects boundaries of the area 31 to enable a player interaction within the area 31 to be detected. The effect of the player's interaction to the area 31 may be likened to the player “rubbing” the area 31 on the underlying symbol or other component of the game play as a good luck gesture to invoke a randomly applied bonus. This may be prior to the game play or it may be during the game play, or event past play but prior to a win outcome being awarded. Thus, if the area 31 is not visible to the player, the player may perceive interaction with the underlying component of the game such as a symbol or position of a reel. The area 31 does not have to correspond to a component of the game but could correspond to a discreet “good luck” area. In addition, there may be multiple areas 31.

In one embodiment the area 31 may be represented by a mascot, and the player's interaction with the mascot (i.e. the area 31) is the trigger to initiate a random bonus. In one embodiment the area 31 may not be on the display 14 but on the console 22 or some other part of the gaming machine 10.

The bonus applied may be a single bonus, or it may be a bonus selected from two or more pre-defined bonuses of:

1. No bonus

2. Free Game

3. Replay with certain components of the game

4. Money back

5. Increasing a return to player percent.

The game controller may be configured to not apply a random bonus if there is no detection of a player's interaction with the area 31.

It should be realised that whilst a “touch screen” is a convenient way to provide detection of a player's interaction with the area 31, other forms of detector sensing may be employed. This could include the use of proximity sensors that define boundaries for the area 31. This could also include the use of a video surveillance type camera that inspects the area 31 to notice a player's gesture to interact with the area 31.

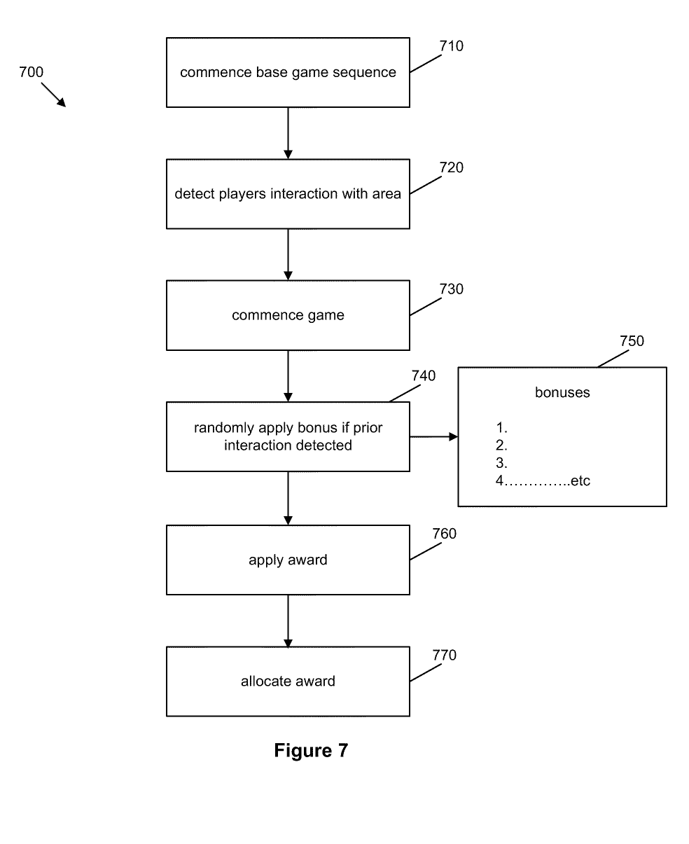

The method 700 of an embodiment of the invention is summarised in FIG. 7. At step 710 it is determined that a base game sequence should commence. The base game may be a chosen game amongst several different games that can be played on the gaming machine 10. Thus the player can select a particular game. Prior to commencement of game play, or even during game play, the area 31 can be monitored for player interaction. The area 31 may be activated for the player interaction prior to commencement of game play and the selecting a particular game or it may be made interactive for player interaction only after selection of a game to play, or after game play and prior to an award being made. In the case where the area 31 is non visible but represented by a component of the game, it may be arranged that the area 31 or position of the area 31 may change from game to game so that it corresponds to different game components for different games. In this way the area 31 may have a random size or position. Whilst these options have been disclosed for non visible area 31, this does not exclude these possibilities for a visible area 31.

The player's interaction with area 31 is detected at step 720. The game is then commenced at step 730. At step 740 a bonus is applied to that game i.e. the next game following the commencement of the game sequence at step 710. In other words, following detection of a player's interaction with area 31 at step 720 the bonus is randomly applied to the next game. The bonus may be a single possible bonus or it may be a bonus randomly chosen from a plurality of different pre-defined bonuses at step 750. An award for game play is then applied at step 760 and the award allocated at step 770.

In a variation of the above, the game controller can be arranged to trigger application of the bonus consequent on a particular win occuring during play. In a variation the area 31 may be made interactive consequent a particular win occurring during game play.

### Example

A player approaches a gaming machine and activates procedures for game play. This may include selecting a particular game from a number of games possible on the gaming machine and it may include initiating the possibility to play by entering tokens, money or using credit as is known in the art. The chosen game then appears on the display 14 and the player can interact with an area 31 either on the display 14 or on the gaming machine itself at some convenient position. The user interaction with the area 31 may be by simply touching a particular area, rubbing a particular area such as a “good luck” stroke, or physically interacting by merely being adjacent the area without physically touching the area. The movement of the player's hand for interaction with the area 31 represents a gesture for the application of a possible “good luck” game play. The player's interaction with the area 31 is noted and the game play is commenced. A random bonus is then applied to the game. The random bonus may be only one possible bonus that is applied randomly such that for some games it is applied, for other games it is not. Alternatively, it may choose from a plurality of possible pre-defined bonuses in a random way or in a sequential way. Thus, in this example the random bonus is applicable to the next game that follows after the detection of the player's interaction with the area 31. This does not exclude player interaction with area 31 after a particular play, and before a final prize is awarded.

Without interaction with the area 31 then no bonus will be applied.

The area 31 may be aligned with particular components of the game such as screen areas, reels in the case of a reel type game, credit meters, or any other aspect.

It should also be appreciated that if a particular combination of win symbols occur during play, that this may be a trigger to activate further games, and the area 31 monitored for further player interaction for the further games and further bonuses appropriately awarded.

The feature will reinforce player's beliefs about luck and how to play a video game.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It will be understood that the invention disclosed and defined in this specification extends to all alternative combinations of two or more of the individual features mentioned or evident from the text or drawings. All of these different combinations constitute various alternative aspects of the invention.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive. Several embodiments are described above with reference to the drawings. These drawings illustrate certain details of specific embodiments that implement the systems and methods and programs of the present invention. However, describing the invention with drawings should not be construed as imposing on the invention any limitations associated with features shown in the drawings. It will be understood that the invention disclosed and defined in this specification extends to all alternative combinations of two or more of the individual features mentioned or evident from the text or drawings. All of these different combinations constitute various alternative aspects of the invention.

The present invention contemplates methods, systems and program products on any electronic device and/or machine-readable media suitable for accomplishing its operations. Certain embodiments of the present invention may be implemented using an existing computer processor and/or by a special purpose computer processor incorporated for this or another purpose or by a hardwired system, for example.

Embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

1. A method of gaming comprising:
providing provision for game play with an outcome,
prior to generation of a game outcome, providing an area with which a player can interact,
detecting a player's interaction with the area and as a consequence randomly applying a bonus for a game outcome.

2. A method as claimed in claim 1, wherein said gaming is undertaken on a video gaming machine and displaying said area on a display screen thereof.

3. A method as claimed in claim 2, further comprising representing said area by a mascot displayed on said display screen.

4. A method as claimed in claim 1, further comprising selecting said random bonus from a plurality of different pre-defined bonuses.

5. A method as claimed in claim 4, wherein said plurality of different bonuses includes two or more of the following:
1. No bonus features
2. Free game
3. Replay with certain components of the game
4. Money back
5. Increasing a return to player percent

6. A method as claimed in claim 1, further comprising not applying a random bonus if there is no detection of a player's interaction with said area.

7. A method as claimed in claim 1, comprising triggering application of said bonus when a particular win occurs during gameplay.

8. A method as claimed in claim 1, comprising detecting a player's interaction with said area and applying said bonus to a next played game.

9. A game controller for a gaming machine, the game controller arranged to:
generate a game outcome on said gaming machine, and to provide an area with which a player will interact,
said game controller being able to receive an input indicating player interaction with said area and to randomly apply a bonus for a game.

10. A game controller as claimed in claim 9, wherein said game machine is a video game machine, and wherein said game controller provides said area on a display screen thereof.

11. A game controller as claimed in claim 10, wherein said game controller represents said area in the form of a mascot.

12. A game controller as claimed in claim 9, wherein said game controller is able to select a random bonus from a plurality of different pre-defined bonuses.

13. A game controller as claimed in claim 12, wherein said plurality of different pre-defined bonuses includes two or more of the following:
1. No bonus
2. Free game
3. Replay with certain components of the game
4. Money back
5. Increasing a return to player percent.

14. A game controller as claimed in claim 9, wherein said game controller is able to trigger said bonus from a particular game play outcome.

15. A game controller as claimed in claim 9, wherein said interaction is determined prior to game play so said bonus is applied to the next game.

16. A gaming system comprising:
a display to enable a player to view game play and to provide an area for player interaction, and
a game controller for a gaming machine, the game controller arranged to:
generate a game outcome on said gaming machine, and to provide an area with which a player will interact,
said game controller being able to receive an input indicating player interaction with said area and to randomly apply a bonus for a game.

17. A tangible computer readable storage medium comprising computer readable instructions which when executed by a processor implements a method of gaming comprising:
providing provision for game play with an outcome,
prior to generation of a game outcome, providing an area with which a player can interact,
detecting a player's interaction with the area and as a consequence randomly applying a bonus for a game outcome.
